(19) United States
(12) Patent Application Publication
(10) Pub. No.: US 2026/0194120 A1
(43) Pub. Date: Jul. 9, 2026

(54) GEAR OR SHAFT COMPRISING A MASS DAMPER

(71) Applicants: ZF FRIEDRICHSHAFEN AG, Friedrichshafen (DE); ZF Wind Power Antwerpen N.V., Lommel (BE)

(72) Inventors: Emre KANPOLAT, Brussels (BE); Sebastian SCHMIDT, Zellingen (DE); Luc JONCKHEERE, Gochsheim (DE)

(21) Appl. No.: 19/128,566

(22) PCT Filed: Oct. 23, 2023
(86) PCT No.: PCT/EP2023/079402

§ 371 Date: May 9, 2025

(30) Foreign Application Priority Data
Nov. 23, 2022 (DE) 10 2022 212 522.3

(51) Int. Cl. F16F 15/14; F16H 57/00

(52) U.S. Cl. CPC F16F 15/1428; F16F 15/1442; F16H 57/0006; F16F 2222/08; F16F 2232/02; F16F 2236/08; F16H 2057/0012

(57) ABSTRACT

A gearbox, including at least one vibration damper and a gearwheel or a shaft. The at least one vibration damper is attached to the gearwheel or the shaft of the gearbox. The at least one vibration damper can have a primary damping mass which is coupled to the gearwheel or the shaft via one or more springs or via one or more dampers.

### CROSS REFERENCE TO RELATED APPLICATIONS

This application is a U.S. National Phase application under 35 U.S.C. § 371 of International Application No. PCT/EP2023/079402, filed on Oct. 23, 2023, and claims benefit to German Patent Application No. DE 10 2022 212 522.3, filed on Nov. 23, 2022. The International Application was published in German on May 30, 2024 as WO 2024/110132 A1 under PCT Article 21(2).

### FIELD

The invention relates to a gearbox.

### BACKGROUND

Wind turbine gearboxes are often exposed to critical vibrations. These can damage the gearbox and lead to unwanted noise emissions.

### SUMMARY

In an embodiment, the present disclosure provides a gearbox, comprising at least one vibration damper and a gearwheel or a shaft. The at least one vibration damper is attached to the gearwheel or the shaft of the gearbox.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a vibration damper on a sun gear;

FIG. 2 illustrates a vibration damper mounted on a generator side on a sun shaft;

FIG. 3 illustrates a vibration damper mounted on a rotor side on a sun shaft;

FIG. 4 illustrates the mounting of a vibration damper inside a sun shaft;

FIG. 5 illustrates a vibration damper on an output shaft;

FIG. 6 illustrates a vibration damper mounted on the rotor side on an output shaft; and

FIG. 7 illustrates a vibration damper mounted on an intermediate shaft.

### DETAILED DESCRIPTION

In an embodiment, the present disclosure provides for improved vibration behavior of a gearbox.

The gearbox according to the present disclosure has at least one vibration damper. This is a means for eliminating and/or reducing structure-borne noise.

According to the present disclosure, the vibration damper is attached to a gearwheel or a shaft of the gearbox. This means that the vibration damper or a part of the vibration damper is joined to the gearwheel or the shaft. Preferably, the vibration damper absorbs rotational vibrations of the gearwheel and/or shaft.

The gearwheel is preferably rotationally fixed to the shaft. In particular, the gearwheel can be joined to the shaft, preferably in one piece.

By attaching the vibration damper directly to the gearwheel or the shaft according to the present disclosure, structure-borne noise can be eliminated at the point where it is generated. This prevents the structure-borne noise from spreading in the gearbox and causing damage or being emitted as excessively loud noise and/or airborne noise.

In an embodiment, the at least one vibration damper has a primary damping mass. This is a one-piece or multi-piece means that is subjected to vibrations via one or more springs and/or via one or more dampers of the vibration damper. Preferably, these are rotational vibrations.

The term spring is used here to describe a means that couples two elements with each other and opposes movements of these elements relative to each other with a spring force. The spring can be configured as a steel spring or an elastomer. Springs with a non-linear characteristic curve or springs whose spring stiffness is variable depending on a signal can also be used.

A damper is a means that dampens the relative movements of the two elements.

In the present case, the primary damping mass is coupled to the gearwheel or shaft via the springs and/or dampers. This means that the two elements are the primary damping mass and the gearwheel or shaft. Accordingly, the springs and/or dampers are joined to the primary damping mass on one side and to the gearwheel or shaft on the other side. According to an embodiment, the primary damping mass is movable, preferably rotationally movable, relative to the gearwheel and/or shaft.

In an embodiment, the vibration damper has a secondary damping mass in addition to the primary damping mass. The secondary damping mass is also preferably configured as a single piece. It is joined to the gearwheel or the shaft.

In an embodiment, the primary damping mass is not coupled directly to the gearwheel or the shaft, but via the secondary damping mass. This means that the primary damping mass is coupled to the secondary damping mass via the one or more springs and/or via the one or more dampers. According to an embodiment, the elements whose relative movements counteract the springs and/or which are damped by the dampers are the primary damping mass and the secondary damping mass. Specifically, the springs and/or dampers are joined on one side to the primary damping mass and on the other side to the secondary damping mass. In an embodiment, the primary damping mass is movable relative to the secondary damping mass, preferably rotationally movable.

The secondary damping mass is preferably configured as a housing. The springs and/or dampers of the vibration damper are arranged in this housing.

In an embodiment, the primary damping mass and/or the secondary damping mass are rotationally symmetrical to a rotation axis of the gearwheel, which is identical to a rotation axis of the shaft. Preferably, the primary damping mass and/or the secondary damping mass are also arranged concentrically to the axis of rotation. This results in balanced rotational behavior without imbalances.

Furthermore, the primary damping mass and/or the secondary damping mass preferably have the basic shape of a toroid. This is a body of rotation with a central hole. The body of rotation is created by the rotation of a surface around a rotation axis. The surface is roughly a rectangle.

The basic shape of a body or part of a body refers to the shape of an original body or part of a body from which the first-mentioned body and/or part was created by eliminating individual areas, for example by inserting recesses and/or by adding individual areas, or whose shape corresponds to the shape of the first-mentioned body.

In an embodiment, the primary damping mass and/or the secondary damping mass have a continuous recess. This is particularly the case if the primary damping mass and/or the secondary damping mass have the basic shape of a toroid. In an embodiment, the shaft extends through the recess in the primary damping mass and/or through the recess in the secondary damping mass.

The shaft can be located in a torque flow running from an input shaft of the gearbox to an output shaft of the gearbox and accordingly be subjected to a torque that is part of this torque flow. In an embodiment, however, the shaft is torque-free. The shaft is therefore not located in a torque flow running from an input shaft to an output shaft.

Instead, in an embodiment, the shaft is driven by another shaft, which in turn is located in the aforementioned torque flow. The other shaft therefore transmits a torque that is part of the torque flow. It is connected to the first-mentioned shaft in a drive-effective manner, so that this shaft is driven by the other shaft. The drive preferably takes place in such a way that the first-mentioned shaft rotates faster than the other shaft. This causes oscillations of the first-mentioned shaft to be transmitted to the other shaft with increased amplitude. This is advantageous as the damping performance is increased.

The gearbox is preferably configured as a wind turbine gearbox. Such an embodiment is advantageous, as the vibration problems described above are particularly pronounced in wind turbine gearboxes.

The gearbox is preferably configured with at least one planet stage. The above-mentioned shaft is further formed as the sun shaft of this planet stage. According to an embodiment, the above-mentioned gearwheel forms a sun gear of the planet stage.

Preferably, an input shaft of the gearbox is further configured as a hollow shaft. The input shaft and the above-mentioned shaft are aligned coaxially to each other, i.e. have the same axis of rotation.

An input shaft further configured as a hollow shaft is advantageous because it allows, in accordance with a method according to the present disclosure, the vibration damper to be guided through the input shaft and attached to the gearwheel or the above-mentioned shaft. Preferably, a planet carrier of the planet stage described above is also hollow for this purpose, i.e. exhibits at least one central and/or centered recess with respect to its axis of rotation. In particular, a cheek, preferably a rotor-side cheek of the planet carrier can have such a recess. This allows a gearbox to be retrofitted with the vibration damper in the mounted state. In particular, a wind turbine gearbox can be retrofitted in the tower of a wind turbine.

Embodiments of the present disclosure are shown in the figures. Corresponding reference numerals thereby indicate identical or functionally identical features.

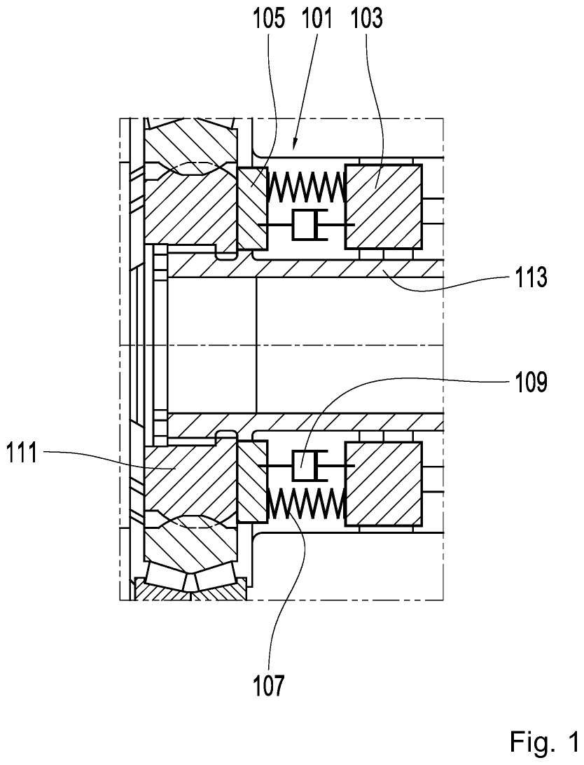

FIGS. 1 to 7 each show a vibration damper 101. This damper exhibits a primary damping mass 103 and a secondary damping mass 105. The primary damping mass 103 is coupled to the secondary damping mass via springs 107 and dampers 109.

The secondary damping mass 105 is used to absorb and reduce vibrations of a component. For this purpose, the secondary damping mass 105 is rigidly fixed in the component, i.e. without the possibility of relative movement between the secondary damping mass 105 and the component.

According to FIG. 1, the component in which the secondary damping mass 105 is fixed is a sun gear 111 of a wind turbine gearbox. Starting from the sun gear 111, the vibration damper 101 is arranged on the generator side. The secondary damping mass 105 is fixed in an end face of the sun gear 111 on the generator side.

The sun gear 111 is non-rotatably connected to a sun shaft 113. This shaft runs through a central hole in the primary damping mass 103 and the secondary damping mass 105.

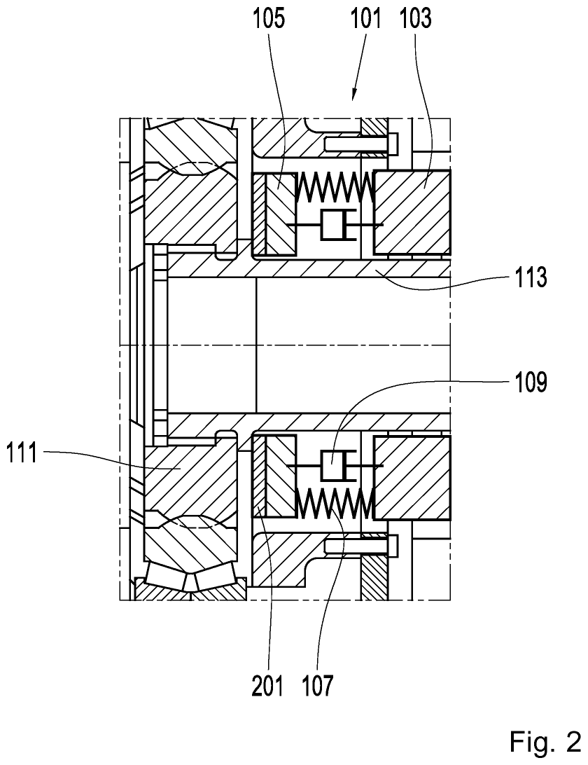

The vibration damper 101 shown in FIG. 2 differs from the vibration damper in FIG. 1 in that the secondary damping mass 105 is not attached to the sun gear 111, but to the sun shaft 113. For this purpose, the sun shaft 113 has a flange 201. The secondary damping mass 105 is joined to this flange.

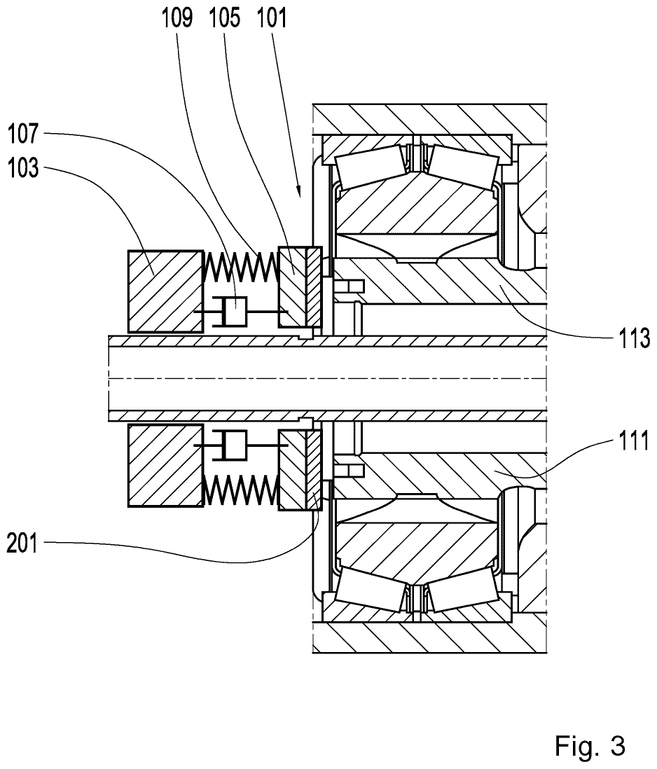

As shown in FIG. 2, the flange 201 and correspondingly the vibration damper 101 are located on the generator side, starting from the sun wheel 111. A rotor-side arrangement, on the other hand, is shown in FIG. 3. Here the flange 201 of the sun shaft 113 is located on the rotor side, starting from the sun gear 111. Accordingly, the vibration damper 101 is arranged on the rotor side.

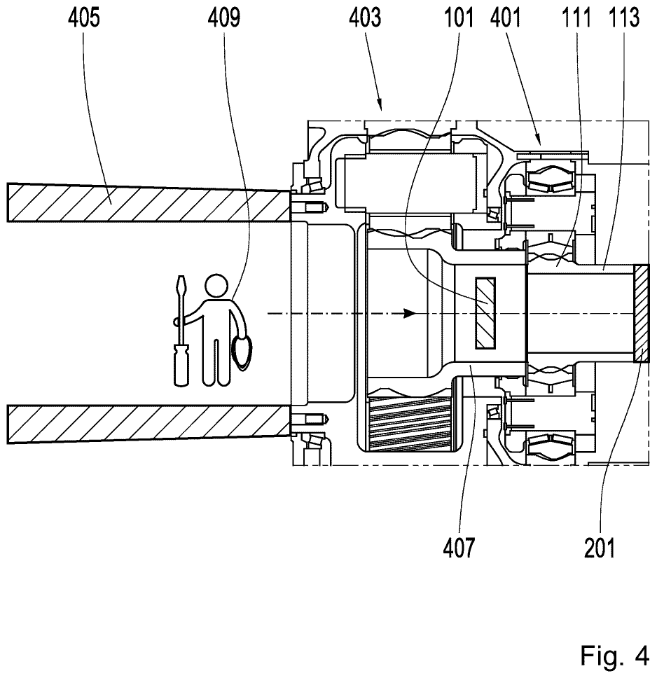

According to FIG. 4, the sun gear 111 described above is part of a planet stage 401 on the generator side. This planet stage 401 is connected downstream of a planet stage 403 on the rotor side. The rotor-side planet stage 403 is in turn coupled to a rotor shaft 405.

A sun shaft 407 of the rotor-side planet stage and the rotor shaft 405 are configured as hollow shafts. This enables an assembler 409 to guide the vibration damper 401 through the rotor shaft 405 and the sun shaft 407 of the rotor-side planet stage 403 and to fix it to the flange 201.

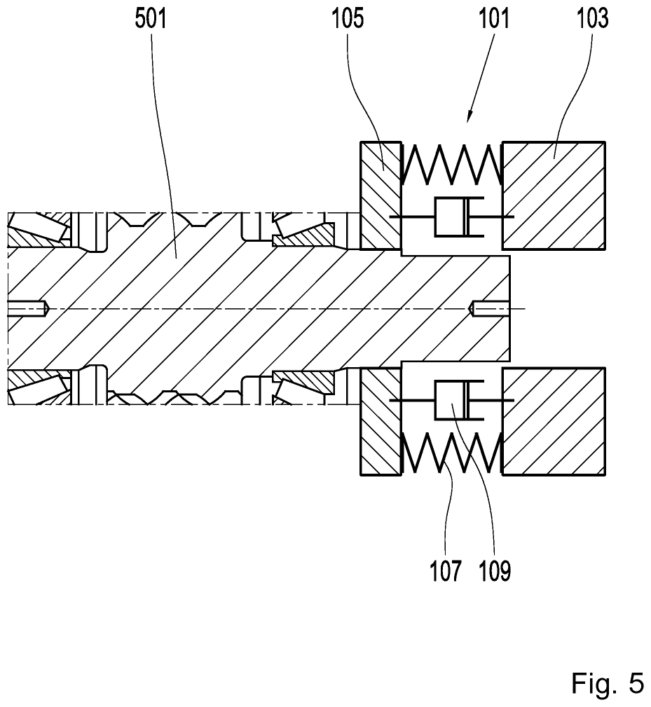

As shown in FIG. 5, the vibration damper 101 can also be mounted on an output shaft 501. The output shaft 501 is part of a spur gear stage. It protrudes from a housing of the gearbox on the generator side. The vibration damper 101 is mounted there.

Specifically, the secondary damping mass 105 is joined to the output shaft 501 outside the gearbox housing. The primary damping mass 103, the springs 107 and the dampers 109 are also located outside the gearbox housing. The arrangement of the vibration damper 101 outside the gearbox housing allows for subsequent assembly.

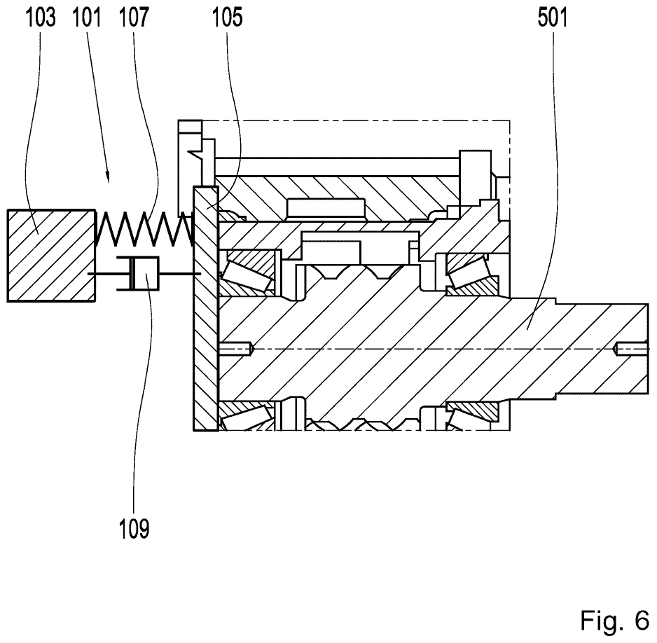

The vibration damper 101 can also be attached on the rotor-side end face of the output shaft 501. Such an arrangement is shown in FIG. 6. The secondary damping mass 105 is here joined on the end face of the output shaft 501.

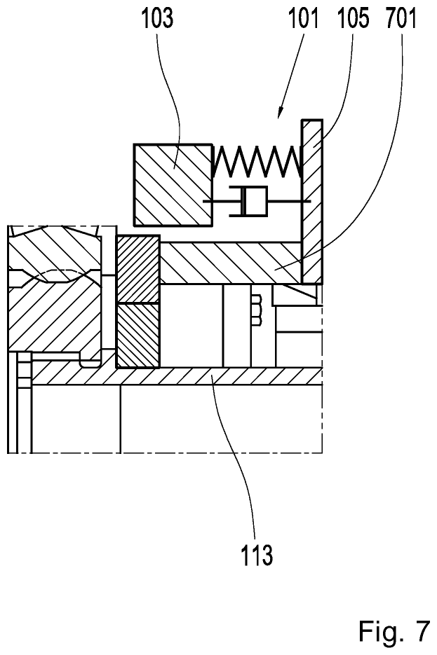

FIG. 7 shows an attachment of the vibration damper 101 to an intermediate shaft 701. The secondary damping mass 105 is joined to the intermediate shaft 701.

The intermediate shaft 701 is driven by the sun shaft 113. It is driven exclusively by the sun shaft 113 and does not drive any other shaft itself. A gear transmission between the sun shaft 113 and the intermediate shaft is configured such that the intermediate shaft 701 rotates faster than the sun shaft. This leads to higher relative accelerations in the vibration damper 101 and thus to a higher damping performance.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

101 vibration damper
103 damping mass
105 damping mass
107 spring
109 damper
111 sun gear
113 sun shaft
201 flange
401 planet stage
403 planet stage
405 rotor shaft
407 sun shaft
409 assembler
501 output shaft
701 intermediate shaft

1. A gearbox, comprising:
at least one vibration damper; and
a gearwheel or a shaft,
wherein the at least one vibration damper is attached to a the gearwheel or the shaft of the gearbox.

2. The gearbox according to claim 1, wherein the at least one vibration damper has a primary damping mass which is coupled to the gearwheel or the shaft via one or more springs and/or via one or more dampers.

3. The gearbox according to claim 1, wherein the at least one vibration damper comprises a primary damping mass and a secondary damping mass;
wherein the secondary damping mass is joined to the gearwheel or the shaft, and
wherein the primary damping mass is coupled to the secondary damping mass via one or more springs and/or one or more dampers.

4. The gearbox according to claim 3, wherein the secondary damping mass forms a housing in which the primary damping mass the one or more springs and/or the one or more dampers are arranged.

5. The gearbox according to claim 2, wherein the primary damping mass is rotationally symmetrical with respect to a rotation axis of the gearwheel and/or the shaft.

6. The gearbox according to claim 5, wherein the primary damping mass is shaped as a toroid.

7. The gearbox according to claim 2, wherein the shaft extends through a recess in the primary damping mass.

8. The gearbox according to claim 1, wherein the shaft does not lie in a torque flow extending from an input shaft to an output shaft and is driven by a shaft lying in the torque flow.

9. The gearbox according to claim 1, wherein the gearbox is configured as a wind turbine gearbox.

10. The gearbox according to claim 1, wherein the shaft is configured as a sun shaft of a planet stage; and
wherein the gearwheel is configured as a sun gear of the planet stage.

11. The gearbox according to claim 1, comprising an input shaft configured as a hollow shaft, wherein the input shaft and the shaft are aligned coaxially to each other.

12. A method for mounting the vibration damper of the gearbox according to claim 11 on the shaft of the gearbox, the method comprising:
guiding the vibration damper through the input shaft and attaching the vibration damper on the gearwheel or the shaft.

13. The gearbox according to claim 3, wherein the primary damping mass and/or the secondary damping mass is rotationally symmetrical with respect to a rotation axis of the gearwheel and/or the shaft.

14. The gearbox according to claim 13, wherein the primary damping mass and/or the secondary damping mass is shaped as a toroid.

15. The gearbox according to claim 3, wherein the shaft extends through a recess in the primary damping mass and/or the secondary damping mass.
